(19) United States
(12) Patent Application Publication
(10) Pub. No.: US 2025/0029452 A1
(43) Pub. Date: Jan. 23, 2025

(54) GAMING SYSTEMS AND METHODS HAVING PERSISTENT EXPANDABLE GAME TIERS ACROSS MULTIPLE GAME INSTANCES

(71) Applicant: Aristocrat Technologies, Inc., Las Vegas, NV (US)

(72) Inventors: Robert Honeycutt, Henderson, NV (US); Adam Bland, Henderson, NV (US)

(21) Appl. No.: 18/732,240

(22) Filed: Jun. 3, 2024

Related U.S. Application Data
(60) Provisional application No. 63/528,276, filed on Jul. 21, 2023.

(51) Int. Cl. G07F 17/32

(52) U.S. Cl. CPC G07F 17/3267; G07F 17/3213

(57) ABSTRACT

An electronic gaming device is disclosed in which a game tier during a bonus game, a free game, and/or a hold-and-spin feature is randomly selected such that the game tier is at least as high as a game tier used during a base game play or higher than the game tier used during the base game play. Game symbols displayed during the base game play, the bonus game, the free game, and/or the hold-and-spin feature are according to a theme associated with a team selected by a game player.

### CROSS-REFERENCE TO RELATED APPLICATION

This application claims priority to and the benefit of U.S. Provisional Patent Application Ser. No. 63/528,276, entitled “PERSISTENT EXPANDABLE GAME TIERS ACROSS MULTIPLE GAME INSTANCES INCLUDING HOLD AND SPIN GAMING SYSTEMS AND METHODS,” filed Jul. 21, 2023, and the content of which is incorporated herein in its entirety for all purposes.

### TECHNICAL FIELD

The field of disclosure relates generally to electronic gaming machines, and more specifically, to systems and methods of expanding game tiers during hold-and-spin feature in which a persistent game tier is maintained across a base game and one or more bonus game features.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming device including at least one memory with instructions stored thereon, and at least one processor in communication with the at least one memory is disclosed. The instructions, when executed by the at least one processor, cause the at least one processor to: (i) determine a first game tier from a plurality of game tiers for playing a base game, each game tier of the plurality of game tiers being assigned a tier level and including a set of value symbols for display during game play, wherein each set of the value symbols included within each game tier have a value associated therewith within a predefined range of values, wherein a minimum value within the predefined range of values increases as the tier level increases; (ii) determine for the base game a first set of game symbols from a plurality of game symbols to be randomly selected from for display on each reel of a plurality of reels, the first set of game symbols including at least value symbols from a set of value symbols corresponding to the first game tier and value symbols included in the game tiers at higher levels than the first game tier; (iii) cause a randomly selected subset of the first set of game symbols to be displayed on the plurality of reels; (iv) in response to one or more trigger symbols being displayed during the base game, trigger a feature game with a particular number of free spins; (v) evaluate the value symbols of the first subset of game symbols displayed on the plurality of reels; (vi) determine the lowest tier level associated with the value symbols displayed on the plurality of reels; (vii) assign a new game tier to the feature game based on the determined lowest tier level displayed; and/or (viii) determine for the feature game a second set of game symbols from the plurality of game symbols to be randomly selected from for the display on the plurality of reels, the second set of game symbols including value symbols corresponding to the new game tier and all other higher tier levels.

In another aspect, a computer-implemented method performed by an electronic gaming device including at least one memory and at least one processor coupled with the at least one memory is disclosed. The method includes (i) determining a first game tier from a plurality of game tiers for playing a base game, each game tier of the plurality of game tiers being assigned a tier level and including a set of value symbols for display during game play, wherein each set of the value symbols included within each game tier have a value associated therewith within a predefined range of values, wherein a minimum value within the predefined range of values increases as the tier level increases; (ii) determining for the base game a first set of game symbols from a plurality of game symbols to be randomly selected from for display on each reel of a plurality of reels, the first set of game symbols including at least value symbols from a set of value symbols corresponding to the first game tier and value symbols included in the game tiers at higher levels than the first game tier; (iii) causing a randomly selected subset of the first set of game symbols to be displayed on the plurality of reels; (iv) in response to one or more trigger symbols being displayed during the base game, triggering a feature game with a particular number of free spins; (v) evaluating the value symbols of the first subset of game symbols displayed on the plurality of reels; (vi) determining the lowest tier level associated with the value symbols displayed on the plurality of reels; (vii) assigning a new game tier to the feature game based on the determined lowest tier level displayed; and/or (viii) determining for the feature game a second set of game symbols from the plurality of game symbols to be randomly selected from for the display on the plurality of reels, the second set of game symbols including value symbols corresponding to the new game tier and all other higher tier levels.

In yet another aspect, an electronic gaming application server communicatively coupled with an electronic gaming device is disclosed. The electronic gaming application server includes at least one memory with instructions stored thereon, and at least one processor in communication with the at least one memory. The instructions, when executed by the at least one processor, cause the at least one processor to: (i) determine a first game tier from a plurality of game tiers for a base game being played on the electronic gaming device, each game tier of the plurality of game tiers being assigned a tier level and including a set of value symbols for display during game play, wherein each set of the value symbols included within each game tier have a value associated therewith within a predefined range of values, wherein a minimum value within the predefined range of values increases as the tier level increases; (ii) determine for the base game a first set of game symbols from a plurality of game symbols to be randomly selected from for display on each reel of a plurality of reels of the electronic gaming device, the first set of game symbols including at least value symbols from a set of value symbols corresponding to the first game tier and value symbols included in the game tiers at higher levels than the first game tier; (iii) cause a randomly selected subset of the first set of game symbols to be displayed on the plurality of reels of the electronic gaming device; (iv) in response to one or more trigger symbols being displayed on the plurality of reels during the base game, trigger a feature game with a particular number of free spins; (v) evaluate the value symbols of the first subset of game symbols displayed on the plurality of reels; (vi) determine the lowest tier level associated with the value symbols displayed on the plurality of reels; (vii) assign a new game tier to the feature game, a new tier level of new game tier is randomly selected to be at least equal to or higher than the determined lowest tier level; and/or (viii) determine for the feature game a randomly selected second set of game symbols from the plurality of game symbols, the second set of game symbols including value symbols corresponding to the new game tier and all other higher tier levels.

In yet another aspect, an electronic gaming machine (EGM) including a display device, a memory device and a game controller is disclosed. The memory device may be configured to store instructions, and the game controller may include a processor that may be configured to execute the instructions stored in the memory device, which, when executed by the processor may cause the game control to determine a first game tier for a base game play, and in accordance with the determined first game tier for the base game play, determine a first set of game symbols of a plurality of game symbols to be displayed on each reel of a plurality of reels while spinning the plurality of reels. The instructions may cause the game controller to trigger a hold-and-spin feature for a particular number of free spin times in accordance with a particular number of specific symbols landing on the plurality of reels in a game matrix area, and determine a second game tier for a first spin of the hold-and-spin feature that is at least as high as a tier having a lowest multiplier value that corresponds with a lowest awarded value for one of the specific symbols during the base game play. The instructions may cause the game controller to determine a second set of game symbols of the plurality of game symbols for displaying with respect to a set of empty positions displayed in the game matrix area in accordance with the determined second game tier. Each empty position of the set of empty positions may correspond with a symbol position in which a specific symbol of the specific symbols did not land when the plurality of reels stopped spinning. Until all positions are occupied with a specific symbol of the specific symbols, or until no specific symbol lands in any empty position for consecutive spins for the particular number of free spin times when spinning stops, the game controller may (i) update the set of empty positions displayed in the game matrix area; and (ii) redetermine the second set of game symbols of the plurality of game symbols for displaying with respect to the updated set of empty positions during spinning and when spinning stops in accordance with the determined second game tier. The instructions may cause the game controller to determine a reward amount based at least in part on the specific symbols in the game matrix area.

In yet another aspect, a computer-implemented method (or method) is disclosed. The method may include determining a first game tier for a base game play, and in accordance with the determined first game tier for the base game play, determining a first set of game symbols of a plurality of game symbols to be displayed on each reel of a plurality of reels while spinning the plurality of reels. The method may include in accordance with a particular number of specific symbols landing on the plurality of reels in a game matrix area, triggering a hold-and-spin feature for a particular number of free spin times, and determining a second game tier for a first spin of the hold-and-spin feature that is at least as high as a tier having a lowest multiplier value that corresponds with a lowest awarded value for one of the specific symbols during the base game play. The method may include, in accordance with the determined second game tier, determining a second set of game symbols of the plurality of game symbols for displaying with respect to a set of empty positions displayed in the game matrix area. Each empty position of the set of empty positions may correspond with a symbol position in which a specific symbol of the specific symbols did not land when the plurality of reels stopped spinning. The method may include, until all positions are occupied with a specific symbol of the specific symbols, or until no specific symbol lands in any empty position for consecutive spins for the particular number of free spin times when spinning stops, (i) updating the set of empty positions displayed in the game matrix area; and (ii) in accordance with the determined second game tier, redetermining the second set of game symbols of the plurality of game symbols for displaying with respect to the updated set of empty positions during spinning and when spinning stops. The method may include determining a reward amount based at least in part on the specific symbols in the game matrix area.

In yet another aspect, an electronic gaming application server communicatively coupled with an electronic gaming machine (EGM) is disclosed. The electronic gaming application server may include a memory device storing instructions, at least one random number generator (RNG), and a game controller including a processor configured to execute the instructions stored in the memory device, which, when executed, cause the game controller to determine a first game tier for a base game play, and in accordance with the determined first game tier for the base game play, determine a first set of game symbols of a plurality of game symbols to be displayed on each reel of a plurality of reels while spinning the plurality of reels on the EGM. The instructions may cause the game controller to, in accordance with a particular number of specific symbols landing on the plurality of reels in a game matrix area when spinning of the plurality of reels stops on the EGM, trigger a hold-and-spin feature for a particular number of free spin times. The instructions may cause the game controller to determine a second game tier for a first spin of the hold-and-spin feature that is at least as high as the first game tier for the base game play or higher than the first game tier, and in accordance with the determined second game tier, determine a second set of game symbols of the plurality of game symbols for displaying with respect to a set of empty positions displayed in the game matrix area. Each empty position of the set of empty positions may correspond with a symbol position in which a specific symbol of the specific symbols did not land when the plurality of reels stopped spinning. The instructions may cause the game controller to, until all positions are occupied with a specific symbol of the specific symbols, or until no specific symbol lands in any empty position for consecutive spin for the particular number of free spin times when spinning stops, (i) update the set of empty positions displayed in the game matrix area; and (ii) in accordance with the determined second game tier, redetermine the second set of game symbols of the plurality of game symbols for displaying with respect to the updated set of empty positions during spinning and when spinning stops. The instructions may cause the game controller to determine a reward amount based at least in part on the specific symbols in the game matrix area. The first game tier, the second game tier, the first set of game symbols, or the second set of game symbols may be determined using the at least one RNG.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A-4H each illustrates an exemplary view of an electronic gaming machine (EGM), in accordance with some embodiments.

FIG. 5 illustrates an exemplary flow-chart of method operations performed by an EGM, in accordance with some embodiments.

### DETAILED DESCRIPTION

In the electronic game play system described herein, a bonus game may be triggered when a predesignated number of specific symbols are displayed on reels during a base game play. During the base game of the embodiment described herein, a game tier is randomly determined using a random number generator (RNG) from a plurality of game tiers. A reel including randomly selected symbols corresponding to the randomly selected game tier may be displayed as the one or more reels spin during the base game. Upon a particular number of trigger symbols (e.g., at least 6 cash-on-reel (COR) symbols) being displayed in a game matrix area when the reels stop spinning, a bonus game may be triggered. For example, the base game matrix may be a 3×5 matrix, which may have 5 reels showing 3 symbols per reel.

In one example of the gaming system described herein, the game matrix during the bonus game may also remain the same, e.g., 3×5 matrix. During the bonus game, the player may get three chances to spin the reels. During the bonus game, symbol positions where no COR symbol is displayed during the base game play may spin, and if a COR symbol lands in any of the positions where COR symbol had not been displayed during the base game on the game matrix, the player may get additional free spins. The credit value corresponding to each COR symbol during the base game and bonus game may be selected based on a game tier that is randomly selected by an RNG.

For example, the electronic gaming device described herein may include at least one memory with instructions stored thereon, and at least one processor in communication with the at least one memory. The instructions, when executed by the at least one processor, cause the at least one processor to: determine a first game tier from a plurality of game tiers for playing the base game, wherein each game tier of the plurality of game tiers is assigned a tier level (e.g., tier level 1, tier level 2, tier level 3, tier level N) and includes a set of value symbols (CORs) for display during game play, wherein each set of the value symbols included within each game tier have a value associated therewith within a predefined range of values (e.g., tier 1 having CORs from 25 credits to 50 credits), wherein a minimum value within the predefined range of values increases as the tier level increases (e.g., tier 2 having CORs from 50 credits to 75 credits).

The electronic gaming device having at least one processor is further programmed to determine for the base game a first set of game symbols from a plurality of game symbols to be randomly selected from for display on each reel of a plurality of reels, the first set of game symbols including at least value symbols from a set of value symbols corresponding to the first game tier (so CORs from tier 1 or tier 2, etc.) and value symbols (CORs) included in the game tiers at higher levels than the first game tier.

The at least one processor is further programmed to cause a randomly selected subset of the first set of game symbols to be displayed on the plurality of reels from the first set of game symbols, and in response to one or more trigger symbols being displayed during the base game, trigger a feature game with a particular number of free spins.

The at least one processor is further programmed to evaluate the value symbols (CORs) of the first subset of game symbols displayed on the plurality of reels, determine the lowest tier level associated with the value symbols displayed on the plurality of reels, and assign a new game tier to the feature game based on the determined lowest tier level displayed. In other words, the first game tier that may be assigned to a game may be tier 1. Thus, the system is able to select value symbols assigned to all tiers or tier levels (tiers 1-10) when displaying the symbols during base game play. However, when the feature or bonus game is triggered, the system will evaluate the value symbols displayed to see what the displayed minimum tier level is. And if the minimum level displayed is tier level 3, despite tier 1 being the initially assigned level, then the CORs for the feature game will be selected from tier 3 or higher.

The at least one processor is further programmed to determine for the feature game a second set of game symbols from the plurality of game symbols to be randomly selected from for the display on each reel of the plurality of reels, the second set of game symbols including value symbols (CORs) corresponding to the new game tier and all other higher tier levels. For the example described above, the CORs are selected from tier 3 or better because that is what was displayed. So, the CORs selected from for display are at a higher value than what may been originally assigned to the game.

In another example, the bonus game may be triggered from a base game in a randomly selected game tier mi using an RNG, where i may be 1-n. In the conventional EGM, during the bonus game, a game tier may be again randomly selected using an RNG where the minimum game tier is selected as 1 and the maximum game tier is selected as n. Accordingly, during the bonus game, a game tier is randomly selected that may be lower than a game tier that triggered the bonus game, which may affect the players return on his/her bet. Alternatively, during the bonus game, game symbols associated with the same game tier that triggered the bonus game may be displayed. Accordingly, during the bonus game, a player's return on his/her bet may be lower.

In one embodiment of the gaming system described herein, the value of n may be 3, so the credit values for tiers 1 through 3 may be according to following table.

TABLE 1

| Tier 1 | Tier 2 | Tier 3 |
|---|---|---|
| X100 | X100 | X100 |
| X50 | X50 | X50 |
| X20 | X20 | X20 |
| X15 | X15 | X15 |
| X10 | X10 | X10 |
| X5 | X5 | X5 |
| X4 | X4 | X4 |
| X3 | X3 | X3 |
| X2 | X2 | X2 |
| X1 | X1 | X1 |

In Table 1 above, different multiplier values for each of tier 1, tier 2, and tier 3 are shown. One or more multiplier values for a randomly selected tier may be randomly used to populate symbols on a reel. For each tier, different multiplier values may have a different weight assigned such that for each tier, a certain range of multiplier values may have a higher or a lower probability of being selected.

For example, for tier 1, multiplier values ×1 to ×4 may be assigned the same weight, and multiplier values ×5 to ×20 may be assigned the same weight that may be different than the weight assigned to the multiplier values ×1 to ×4. Similarly, for tier 1, multiplier values ×50 and ×100 may be assigned the same weight which may be different from the weights assigned to multiple values ×1-×4 and/or ×5-×20. For tier 2, similarly, multiplier value ranges ×1 to ×4, ×5 to ×20, and ×50 to ×100 may be assigned a respective and a different weight value. For tier 3, multiplier value ranges ×1 to ×20, and ×50 to ×100 may be assigned a respective and a different weight value. Depending on the weight assigned to a multiplier value range, symbols of different credit values may be generated and displayed during the base game play (and/or a bonus game play) in accordance with a RTP determined for the game or the player.

An electronic gaming device, as described herein according to an exemplary embodiment, may randomly select the minimum game tier as the game tier that triggered the bonus game (e.g., a hold-and-spin feature). Accordingly, during the bonus game, game symbols corresponding to a game tier that is equal to or higher than a game tier that triggered the bonus game may be displayed. Since the return to the player may increase as a higher game tier is selected during a game, the player may see greater variability in credit returns and, in some cases, a higher return on his/her wager.

By way of an example, n may be any value. In one example, a value of n may be 10, and, therefore, there may be 10 different game tiers with each having a set of value symbols that cover a range of values with those values increasing for each next level tier. During a base game, a game tier may be randomly selected from 1-10. During the bonus game, a game tier may be randomly selected from the game tier level that triggered the bonus game through tier level 10. By way of an example, a range of certain tiers, for examples, tiers 1 to 4, may be identified or recognized as lower tiers. A return to player (RTP) allocated to higher tiers, for examples, tiers 5 to 10, may have a lower volatility and the RNG may be configured to select a tier from the higher tiers more frequently than from the lower tiers during the base game. Thus, by expanding a total number of tiers, and assigning weights to multiplier values based on the corresponding tier and/or the value of multiplier value, the RTP may be maintained by generating credit symbols corresponding to many different tiers and/or different multiplier values. Additionally, or alternatively, the weight for a multiplier value of a game tier may be assigned such that for a higher tier, lower multiplier value may not be selected and/or may be selected less frequently.

In some embodiments, and by way of a non-limiting example, one or more weighted tables may be used for generating a range of credit values for a game tier during a bonus game that is at least as high as the game tier selected by the RNG during the base game. In one example, the game tier during the bonus game may be at least as high as the lowest game tier selected by the RNG during the base game. Additionally, or alternatively, the game tier during the bonus game may be at least as high as the highest game tier selected by the RNG during the base game.

In some embodiments, and by way of an example, game symbols displayed during the base game may be based on a football theme. In other words, a game player may select a particular football team from a number of football teams, and game symbols, a base game screen, a bonus game screen, one or more overlays, and/or other audio and/or visual presentation on the EGM or electronic gaming device may be in accordance with a theme of the game player's selected football team.

Accordingly, a hold-and-spin feature may be triggered when at least six football symbols are displayed in the game matrix during the base game play. During the hold-and-spin feature, the football symbols that are displayed on the reels during the base game may be held in place and the player may receive, for example, three free spins to spin the reels during which one or more additional football symbols may land in remaining empty symbol positions of the game matrix during the hold-and-spin feature. If during a spin during the hold-and-spin feature, if a new football symbol lands in an empty symbol position, available spins during the hold-and-spin feature are reset to the starting three spins, which this repeats each time a new football symbol lands during the hold-and-spin feature. At the conclusion of the hold-and-spin feature, the player may be awarded a value determined based on each football symbol (associated with a different multiplier value). If three or more bonus symbols land on the reels, a free game may be awarded. During the free game feature, a value corresponding to each football symbol landed on the screen may be immediately awarded to the player.

An exemplary table of tiers and multiplier values for each tier may be as shown below with the shaded multiplier values not being included within that corresponding tier.

In some embodiments, and by way of a non-limiting example, multiplier values selected for landing on an empty position for tier 1 may be ×1 and/or above, multiplier values selected for landing on an empty position for tier 2 may be ×2 and/or above, multiplier values selected for landing on an empty position for tier 3 may be ×3 and/or above, multiplier values selected for landing on an empty position for tier 4 may be ×4 and/or above, and multiplier values selected for landing on an empty position for tier 5 may be ×5 and/or above. For tier 6, tier 7, tier 8, tier 9, and tier 10, multiplier values selected for landing on an empty position may be at least and/or above ×10, ×15, ×20, ×50, and ×100, respectively. Accordingly, based on the randomly selected tier during the base game, free game, bonus game, and/or hold-and-spin feature, different multiplier values may be selected for each COR symbol (or football symbol) for landing on an empty position. Thus, a tier during the bonus game, free game, and/or hold-and-spin feature may be higher than the tier of the base game, and accordingly, a multiplier value may similarly be selected from higher multiplier values.

The embodiments of the present disclosure represent a technical improvement in the art of electronic gaming devices, machines, systems, and operations of such electronic gaming devices or systems. The technical improvements achieved by the present disclosure include at least using an RNG to randomly provide a wide range of persistent game tiers (low and high value tiers) used in a base game and one or more bonus game features, while increasing the frequency of occurrence (or selection) of the higher-value tiers. The embodiments of the present disclosure decouple the tier in the base game from hold-and-spin feature game to allow for potential tiering expansion between the base game and any feature or bonus games, and, thereby, balance game volatility and RTP. Thus, the embodiments described herein include improved game variability and improved control of RTP while maintaining the amount of data storage required and/or computational resources needed to implement this game. Further, embodiments of the present disclosure also improve on the amount of data storage required and the reduction in computational resources needed for this game by selecting different multiplier values based on a selected tier during the bonus game, free game, and/or hold-and-spin feature.

The technical problems addressed herein include at least an inability of known systems to: (i) use a tiering system for applying credit value symbols within a game to provide greater variability while controlling RTP, (ii) decouple the use of a tiering system used in a base game from a hold-and-spin bonus game to allow for potential tiering expansion between the base game and the bonus game, and/or (iii) inability of known systems to improve on the amount of data storage and reduction in the use of computational resources by selecting different multiplier values based on a selected tier during the bonus game.

The resulting technical effects and/or technical benefits achieved by this disclosure include at least ability to decouple the tier in the base game from hold & spin bonus game to allow for potential tiering expansion between the base game and any free or hold & spin features during a bonus game, and/or ability to improve an amount of data storage and use of computation resources by selecting different multiplier values based on a selected tier during the bonus game.

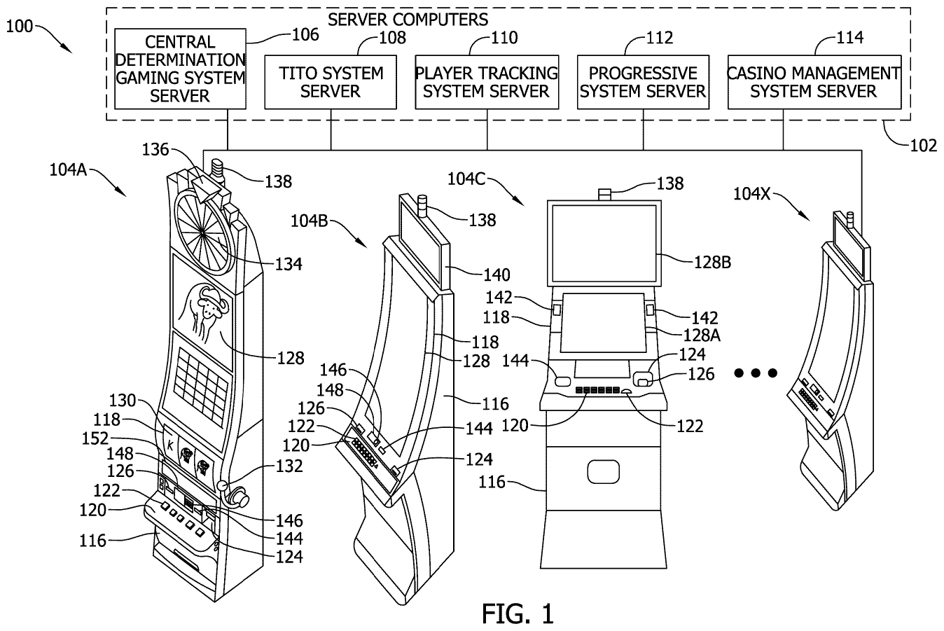

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

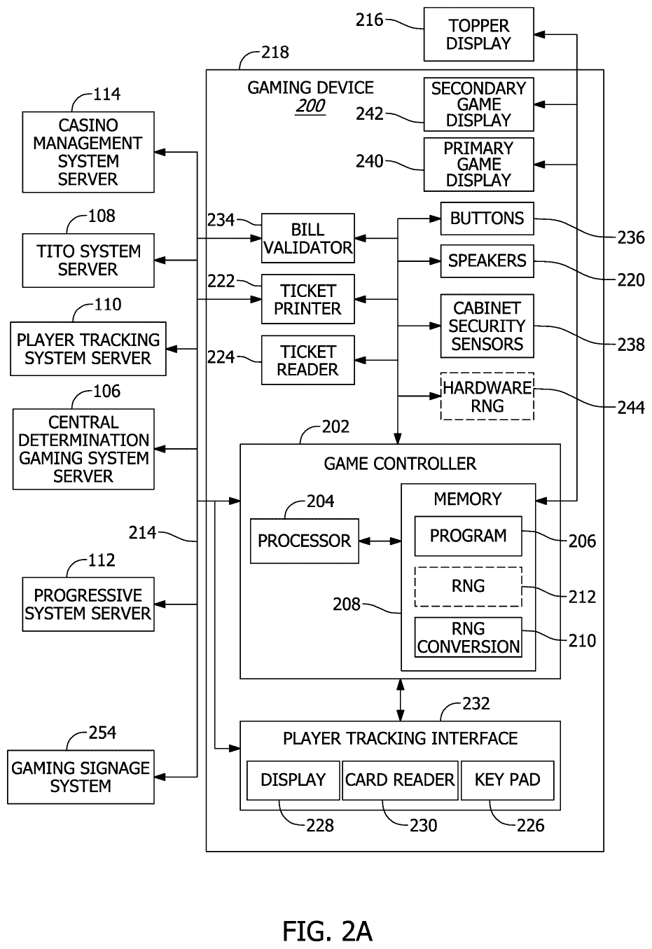

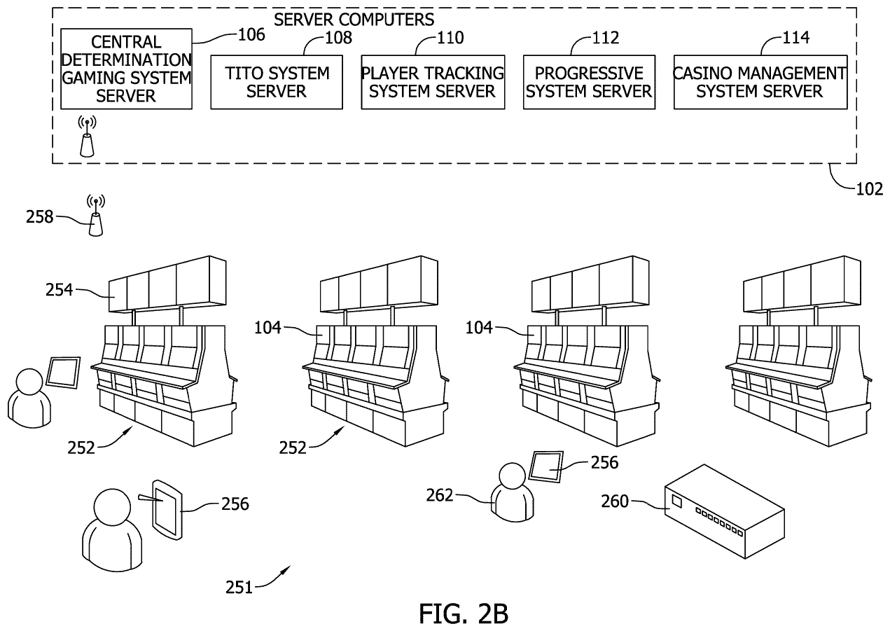

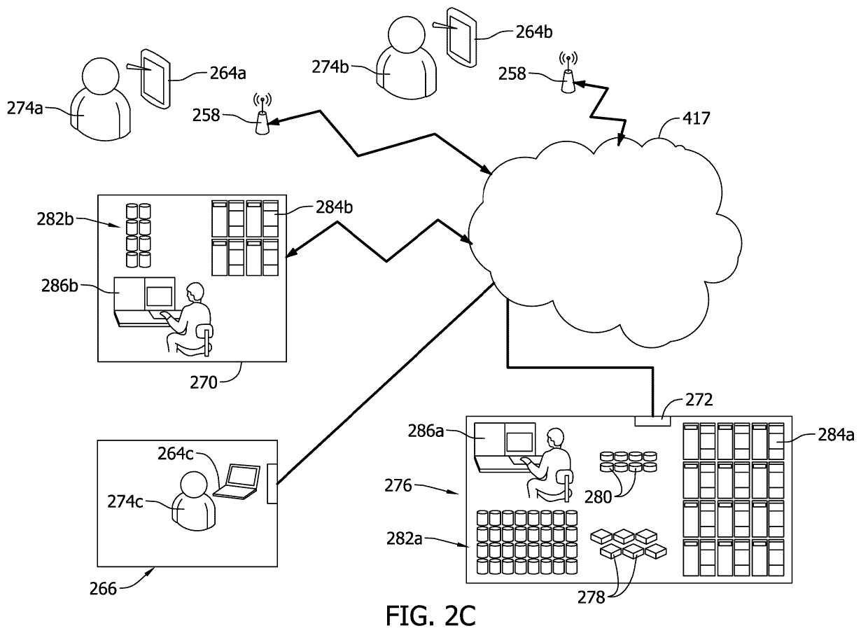

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, a payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

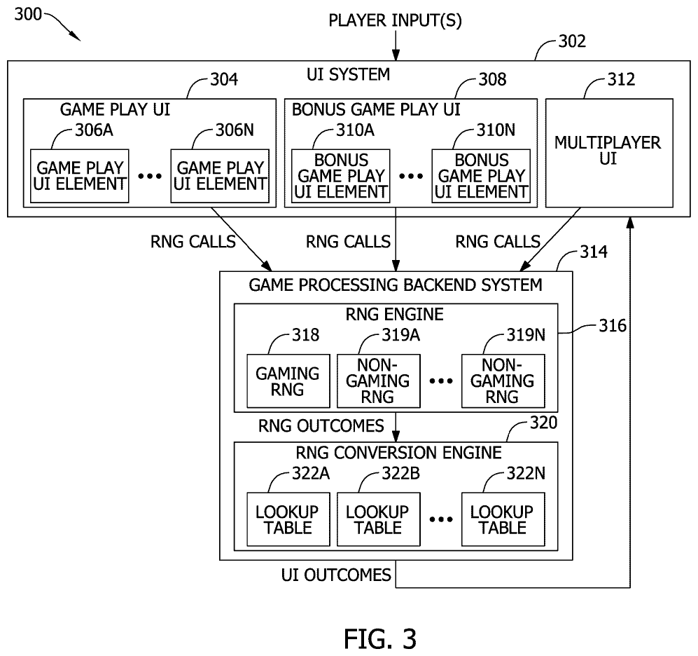

FIG. 3 illustrates, in block diagram form, an implementation of a game processing architecture 300 that implements a game processing pipeline for the play of a game in accordance with various implementations described herein. As shown in FIG. 3, the gaming processing pipeline starts with a UI system 302 receiving one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, or additionally, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

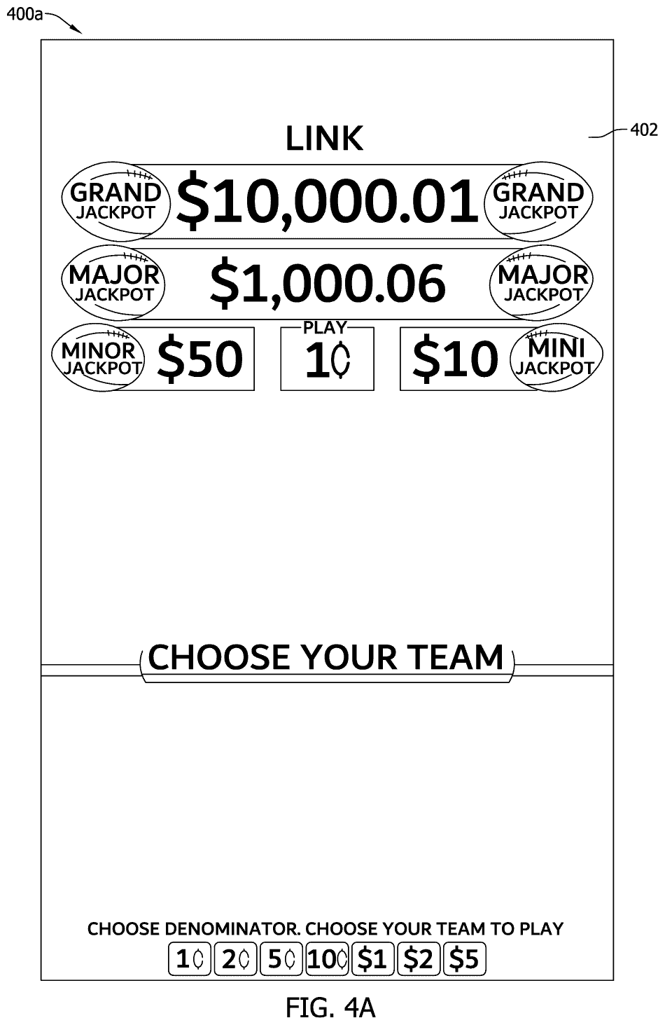

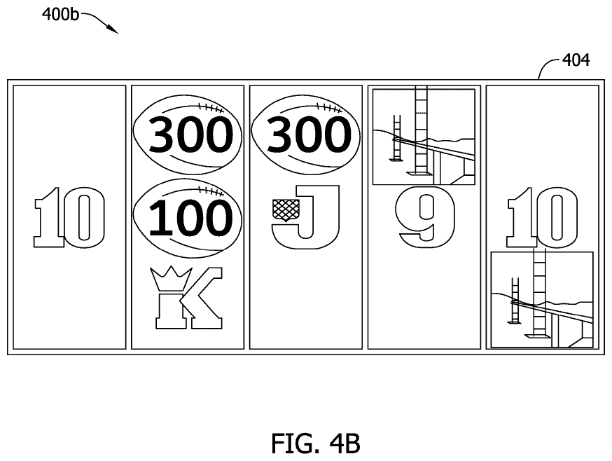

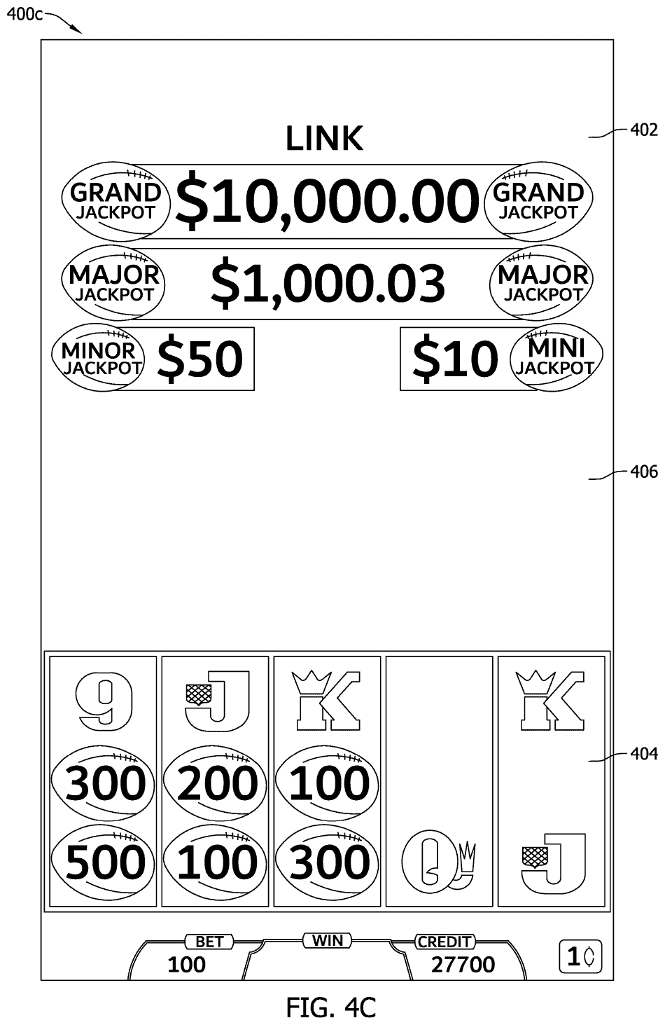

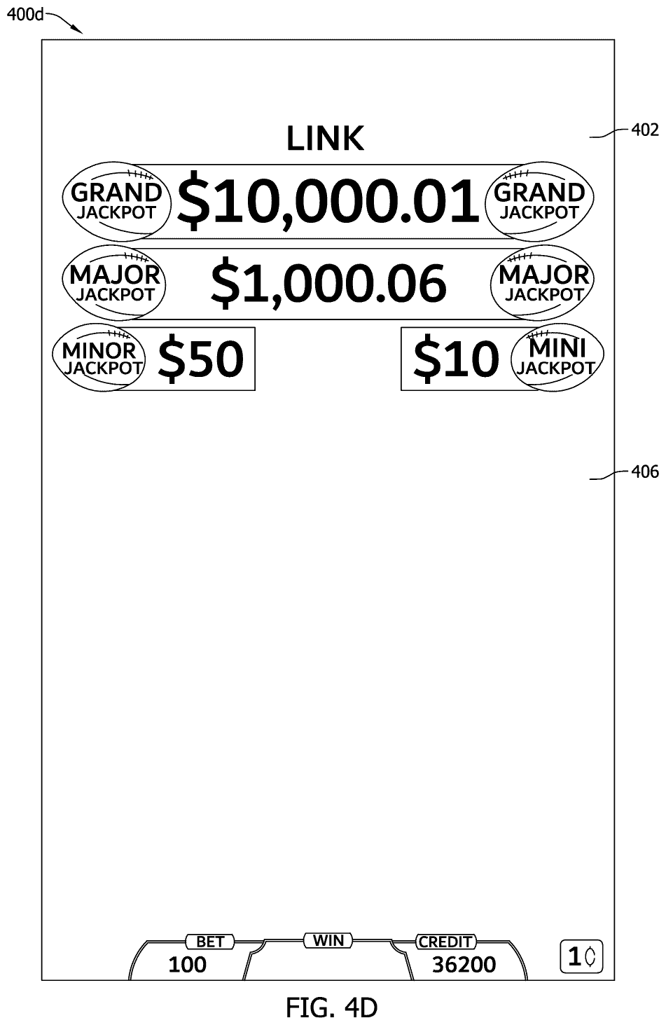

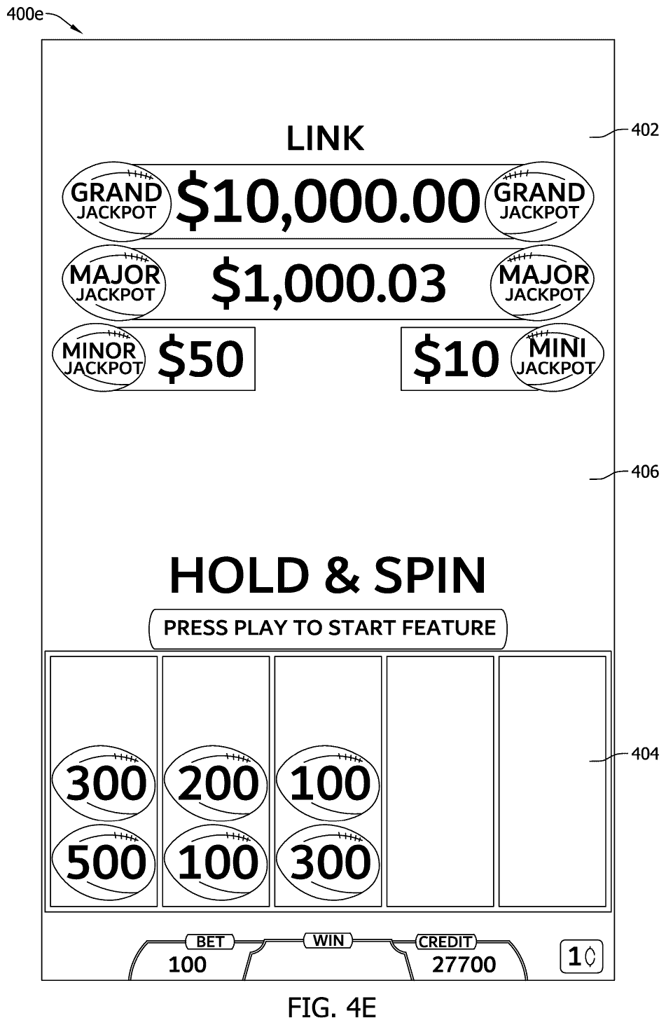

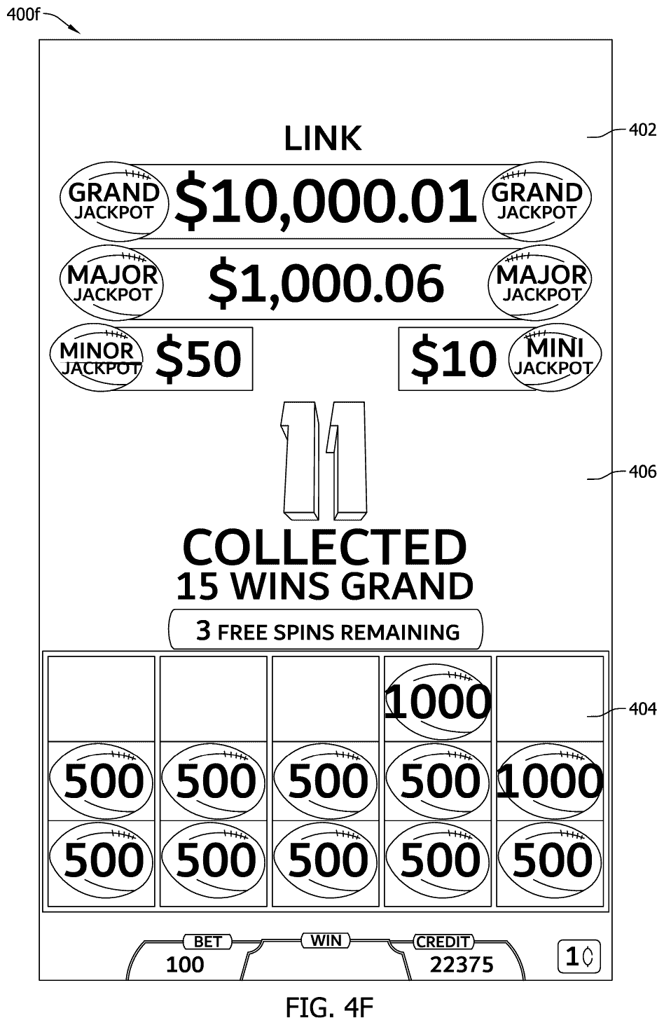

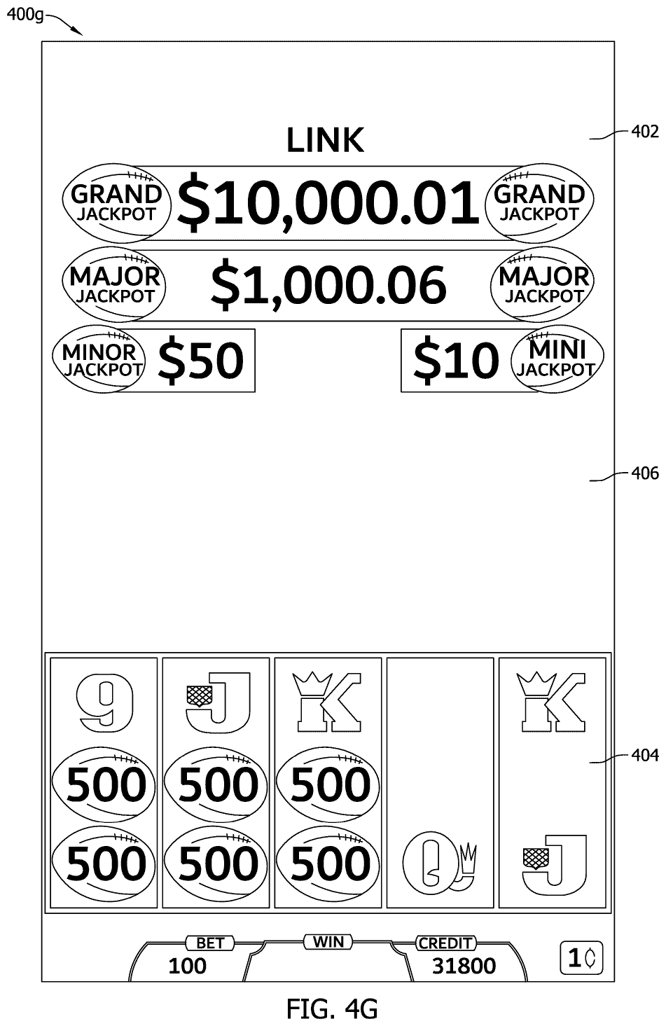

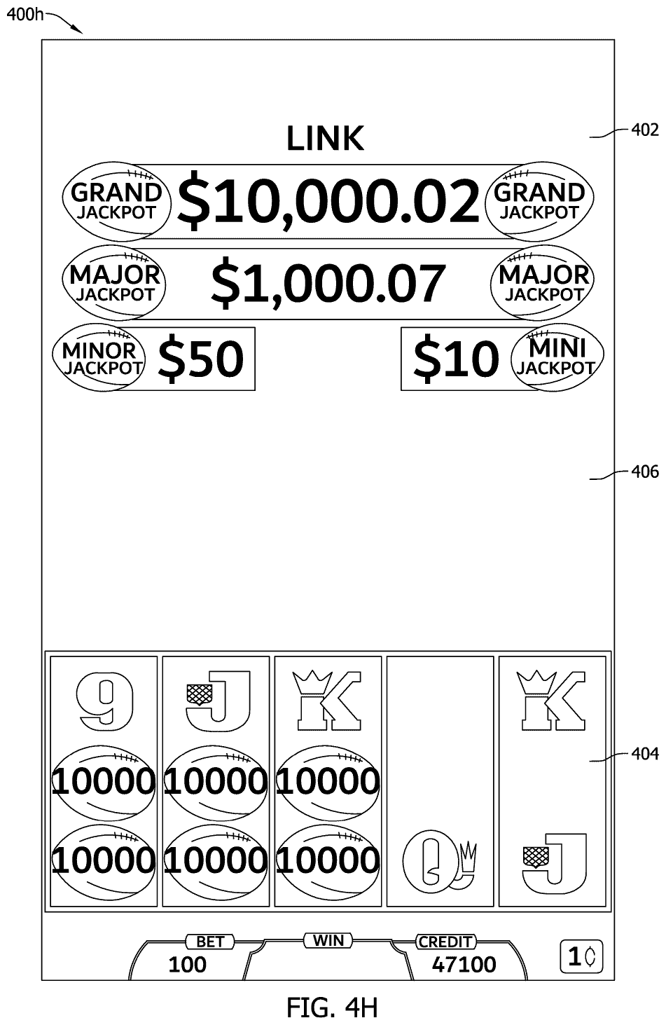

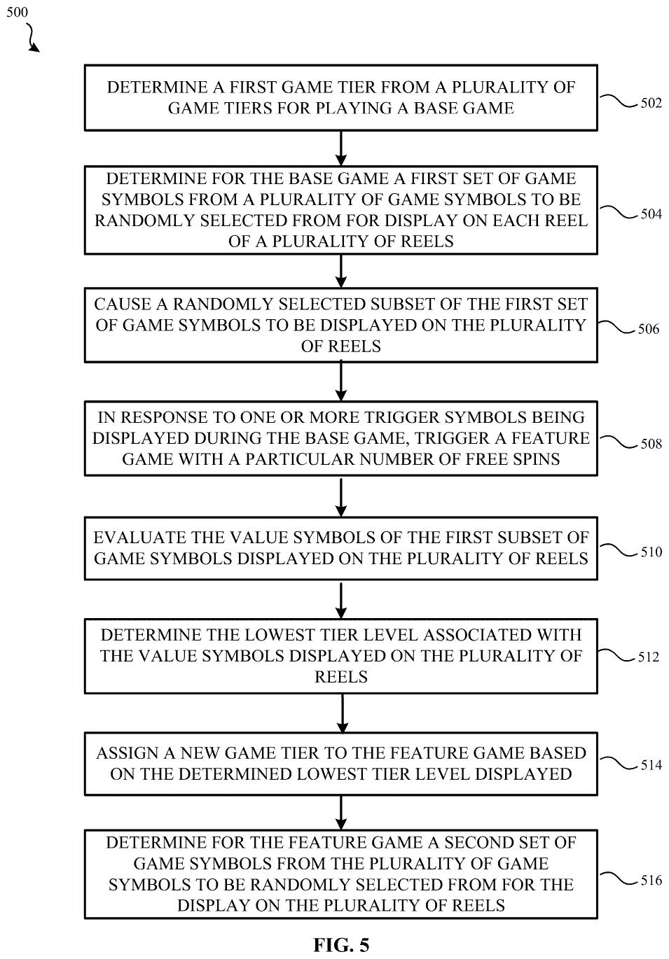

In some embodiments, the UI outcome received by the UI system 302 during the base game, a bonus game, a hold-and-spin feature, and/or a free game may be based on a randomly selected tier (e.g., any tier from tier 1 to tier 10) and a multiplier value for a COR symbol (or a football symbol), as described herein. As stated herein, a game tier during the bonus game, the free game, and/or the hold-and-spin feature may be upgraded or remains same as the tier during the base game but may not be lower than the tier during the base game. Various embodiments are described in more details with respect to FIGS. 4A-4H, and 5.

FIGS. 4A-4H each illustrates an exemplary full or partial view of an electronic gaming device during a base game play, hold-and-spin feature, a bonus game, and/or transition from the base game play to the hold-and-spin feature and/or the bonus game. In an exemplary view 400a as shown in FIG. 4A, on a display of an electronic gaming device 402, multiple football teams may be displayed for a player to select a team for playing on the electronic gaming device 402. The player may select a team using an input device (not shown in FIGS. 4A-4H) or using a touchscreen display of the electronic gaming device 402.

In another exemplary view 400b as shown in FIG. 4B, a game matrix 404 may display symbols in accordance with a theme corresponding to the team selected by the player. As shown in the view 400b, a COR symbol is displayed as a football having a corresponding amount. Assuming that a bet wagered by the player is 100, a football having a corresponding cash amount 100 may indicate that a tier level for this game that is randomly selected by an RNG is tier level 1 or game tier 1, as described herein. Similarly, for other two COR symbols (or football symbols) showing cash amount 300 may indicate that a randomly selected multiplier value may be ×3, as described herein. Other symbols including non-COR symbols displayed in the game matrix 404 are all based on a football theme corresponding to the team selected by the player.

In an exemplary view 400c shown in FIG. 4C, during a base game play, when at least predesignated number of specific symbols or trigger symbols (e.g., 6 COR symbols (football symbols)) land and displayed on the reels as the reels stop spinning, a bonus game and/or a hold-and-spin feature may be triggered. In the exemplary view 400c, while the game matrix 404 may be displayed on the bottom portion of the display of the electronic gaming device 402, football related animation 406 may be displayed. By way of a non-limiting example, football related animation may be related to the player's selected team. As shown in the view 400c, when predesignated number of (e.g.,6) trigger symbols (e.g., COR symbols (or football symbols)) land and displayed on the reels when the reels stopped spinning, a bonus game or a hold-and-spin feature may be triggered. In some examples, the predesignated number of trigger symbols may be required in specific positions in the game matrix 404 for triggering the bonus game or the hold-and-spin feature.

Further, as described herein, assuming the bet wagered by the player is 100, an amount shown on each football may suggest that the game tier of the base game that triggered the bonus game may be tier 1. In some examples, each multiplier value may have a respective color associated with it, and the football may have a halo of color associated with the multiplier value (as shown in FIGS. 4G-4H), and/or other audio and/or visual effects to inform the player that the player has received one or more higher multiplier values.

As described herein, during the bonus game or the hold-and-spin feature, a game tier is randomly selected that is at least as high as a randomly selected tier using an RNG that triggered the bonus game or the hold-and-spin feature. By way of an example, if the game tier that triggered the bonus game or the hold-and-spin feature is game tier 1, the game tier that is randomly selected for the bonus game or the hold-and-spin feature may not be less than game tier 2 (game tier 2 is higher than game tier 1). Similarly, if the game tier that triggered the bonus game or the hold-and-spin feature is game tier 10, the game tier that is randomly selected for the bonus game or the hold-and-spin feature may not be less than game tier 10 (game tier 10 is the highest tier).

As the bonus game or the hold-and-spin feature is triggered, as shown in an exemplary view 400d in FIG. 4D, the game matrix 404 may be (temporarily) removed from the display of the electronic gaming device 402. A transition animation similar to shown by 406 in the view 400d may be (temporarily) displayed on the display of the electronic gaming device 402. Additionally, or alternatively, other audio effects may be played as well along with the display of the transition animation.

An exemplary view 400e shown in FIG. 4E may corresponds with a bonus game or a hold-and-spin feature. As shown in the view 400e, the game matrix 404 may display trigger symbols or COR symbols (or football symbols) in their respective positions when the reels stopped spinning during the base game. Other non-COR symbols that were landed on the reels when the reels stopped spinning during the base game may be cleared or removed. As the player initiates the bonus game or the hold-and-spin feature, a reel corresponding to each empty position, where the trigger symbol or COR symbol is not displayed, may start spinning and then stop.

As the reel corresponding to each empty position stops spinning, a symbol (e.g., a COR symbol (or a football symbol) or a non-COR symbol) may be displayed on each empty position. During the bonus game or the hold-and-spin feature, the player may get, for example, three chances to spin the reels corresponding to one or more empty positions. If a COR symbol (or a football symbol) is displayed when the reels corresponding to the one or more empty positions stop spinning, the player may again get certain number of chances (e.g., three chances) to spin the reels corresponding to remaining one or more empty positions because only COR symbols (or football symbols) are retained in their positions, and non-COR symbols removed from displaying and thus forming remaining one or more empty positions.

An exemplary view 400f in FIG. 4F may correspond with a case where during each spin of the bonus game or hold-and-spin feature, at least one COR symbol (or football symbol) is displayed in an empty position. As shown in the view 400f, the player has collected 11 football symbols and the player may win a grand prize if the player collects 15 football symbols. As shown in exemplary views 400g and 400h in FIG. 4G and FIG. 4H, respectively, each COR symbol (or football symbol) may be displayed with a halo of color associated with a multiplier value of the COR symbol (or football symbol).

FIG. 5 illustrates an exemplary flow-chart 500 of method operations performed by an electronic gaming device, in accordance with some embodiments. The electronic gaming device may include a display device. In some examples, the electronic gaming device may include an interface device coupling the electronic gaming device with an electronic gaming server. The electronic gaming device may include at least one memory that is configured to store instructions thereon, which may be executed by at least one processor of the electronic gaming device in communication with the at least one memory. The at least one processor is configured to execute the instructions stored in the at least one memory and/or instructions received from the electronic gaming server. One or more instructions received from the electronic gaming server and/or executed by the electronic gaming device may be generated using at least one RNG. By way of a non-limiting example, the electronic gaming device may be an electronic gaming machine, or a user equipment such as a smartphone, a tablet, a laptop, a smart glass, and so on.

The electronic gaming device may receive an amount of bet wagered by a player on the electronic gaming device. The bet wagered by the player on the electronic gaming device may be cash, tokens, and/or credits, and so on. The bet may be wagered by the player in other forms as well. In response to the received amount of bet or wager, and in response to the user input to begin a base game play, a first game tier for a base game play may be determined (502). The first game tier may be randomly determined using at least one RNG. As described herein, the first game tier may be selected from a plurality of game tiers. By way of a non-limiting example, the plurality of game tiers may include a specific number of game tiers, for example, 10 tiers such as game tier 1 to game tier 10. Each game tier may be assigned a tier level and include a set of value symbols for display during the game play. Each set of the value symbols included within each game tier, or associated with each game tier, may have a value associated therewith within a predefined range of values. A minimum value within the predefined range of values increases as the tier level increases. Each game timer may be assigned a respective weight that may cause a subset of the plurality of tiers may be selected less frequently in comparison with another subset of the plurality of tiers. For example, for game tiers 1 to 10 described herein, game tiers 1 to 4 may be assigned a respective weight such that game tiers 1 to 4 may be selected less frequently in comparison with game tiers 5 to 10.

A first set of game symbols may be determined (504) from a plurality of game symbols for display one each reel of a plurality of reels of a game matrix. The first set of game symbols may be randomly selected and include at least value symbols from a set of value symbols corresponding to the determined (502) first game tier and value symbols included in the game tiers at higher tier levels than the tier level of the first game tier. The first set of game symbols may be determined for displaying on each reel of the plurality of reels. The plurality of symbols includes COR symbols and/or non-COR symbols. The COR symbols and/or the non-COR symbols may be according to a theme associated with a team selected by a game player. By way of a non-limiting example, the team selected by the game player may be a football team. However, the theme may be associated with any sport and/or a team associated with any sport. The plurality of symbols may also include one or more mini jackpot symbols, and/or one or more major jackpot symbols. A randomly selected subset of the first set of game symbols may be caused (506) to be displayed on the plurality of reels. The randomly selected subset of the first set of game symbols displayed on the plurality of reels may include one or more trigger symbols.

Accordingly, in response to one or more trigger symbols being displayed during the base game, a feature game may be triggered (508) with a particular number of free spins. By way of a non-limiting example, the particular number of free spins may be 3 free spins. The trigger symbol may be a COR symbol (or a football symbol). The trigger symbol may have a corresponding number, which may specify an amount associated with the trigger symbol. In some examples, a particular number of the trigger symbols may be required to be displayed on the plurality of reels in a specific pattern or on specific positions in the game matrix area. The game matrix area may be 3×5, as described herein.

The value symbols of the first subset of game symbols displayed on the plurality of reels may be evaluated (510) and the lowest tier level associated with the value symbols displayed on the plurality of reels may be determined (512). In other words, the lowest awarded value of the value symbols of the first subset of game symbols displayed on the plurality of reels may be determined for determining the lowest multiplier value for the wager of the player. Based upon the determined lowest multiplier value, a game tier that corresponds with the lowest multiplier value may be determined, for example, as described herein with respect to Table 2.

A new game tier to the feature game may be assigned (514) based on the determined lowest tier level. In one example, assuming that the randomly selected first game tier is game tier 2. As described herein, using Table 2, for game tier 2, the minimum multiplier value is ×2. Assuming further that, a trigger symbol displayed has the lowest awarded value of 400 for a bet wagered by the player of 100, the multiplier may be determined to be ×4, which is a lowest multiplier value corresponding to game tier 4. Accordingly, the lowest tier level determined (512) may be at least as high game tier 4, but not less than game tier 4, and, therefore, the new game tier that may be assigned (514) to the feature game may not be less than the game tier 4. By way of a non-limiting example, if the lowest tier level determined in this way is game tier 1 for the lowest awarded value of 100, the assigned (514) new game tier may not be less than game tier 2. In other words, the new game tier may not be game tier 1.

A second set of game symbols from the plurality of game symbols may be randomly determined (516) for displaying on the plurality of reels. The second set of game symbols may include value symbols corresponding to the new game tier and all other higher tier levels. As described herein, COR symbols (or football symbols) displayed in the game matrix area may be persistently displayed in their respective positions, and non-COR symbols may be removed to generate a set of empty positions for the first spin of the hold-and-spin feature. A subset of the second set of game symbols may be displayed in the set of empty positions on the plurality of reels. Each empty position of the set of empty positions does not include a game symbol displayed during the base game or a free spin of the particular number of free spins. During the feature game, a value symbol may be displayed within one of the empty positions on the plurality of reels. The value symbol may be one of the second set of game symbols including value symbols corresponding to the new game tier and all other higher tier levels.

In some examples, a new tier level may be randomly selected and assigned to the new game tier. The new tier level may be equal to or higher than the determined (512) lowest tier level until all symbol positions on the plurality of reels are occupied with a value symbol, or until the particular number of free spins are exhausted. The second set of game symbols may be reselected for each free spin of the particular number of free spins during the feature game. The first set of game symbols, and/or the second set of game symbols may be generated according to a theme associated with a team selected by the player.

Until all positions are occupied with a trigger symbol, or until no trigger symbol lands and displayed in any empty position for consecutive spins for the particular number of free spin times when spinning stops, the set of empty positions displayed in the game matrix area may be updated, and the second set of game symbols of the plurality of game symbols for displaying with respect to the updated set of empty positions may be redetermined for displaying in the game matrix area.

As described herein, the first set of game symbols may include one or more game symbols having a respective multiplier value in accordance with the first game tier. The second set of game symbols may include one or more game symbols having a respective multiplier value in accordance with the new game tier.

Various embodiments, as described herein, may thus provide a wide range of persistent game tiers (low and high value tiers) in a base game and one or more bonus game features in a RNG gaming environment, while increasing the frequency of occurrence (or selection) of the high-value tiers, balancing game volatility and RTP, and decoupling the tier in the base game from hold & spin bonus game to allow for potential tiering expansion between the base game and any free or hold-and-spin features during a bonus game.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device comprising:
at least one memory with instructions stored thereon; and
at least one processor in communication with the at least one memory, wherein the instructions, when executed by the at least one processor, cause the at least one processor to:
determine a first game tier from a plurality of game tiers for playing a base game, each game tier of the plurality of game tiers being assigned a tier level and including a set of value symbols for display during game play, wherein each set of the value symbols included within each game tier have a value associated therewith within a predefined range of values, wherein a minimum value within the predefined range of values increases as the tier level increases;
determine for the base game a first set of game symbols from a plurality of game symbols to be randomly selected from for display on each reel of a plurality of reels, the first set of game symbols including at least value symbols from a set of value symbols corresponding to the first game tier and value symbols included in the game tiers at higher levels than the first game tier;
cause a randomly selected subset of the first set of game symbols to be displayed on the plurality of reels;
in response to one or more trigger symbols being displayed during the base game, trigger a feature game with a particular number of free spins;
evaluate the value symbols of the first subset of game symbols displayed on the plurality of reels;
determine the lowest tier level associated with the value symbols displayed on the plurality of reels;
assign a new game tier to the feature game based on the determined lowest tier level displayed; and
determine for the feature game a second set of game symbols from the plurality of game symbols to be randomly selected from for the display on the plurality of reels, the second set of game symbols including value symbols corresponding to the new game tier and all other higher tier levels.

2. The electronic gaming device of claim 1, wherein the instructions, when executed by the at least one processor, further cause the at least one processor to display a subset of the second set of game symbols in a set of empty positions on the plurality of reels, wherein each empty position of the set of empty positions does not include a displayed game symbol.

3. The electronic gaming device of claim 2, wherein the instructions, when executed by the at least one processor, further cause the at least one processor to cause display of a value symbol within one of empty positions on the plurality of reels, wherein the value symbol is selected from the second set of game symbols including value symbols corresponding to the new game tier and all other higher tier levels.

4. The electronic gaming device of claim 2, wherein the instructions, which, when executed by the at least one processor, further cause the at least processor to reassign the new game tier having a new tier level randomly selected to be equal to or higher than the determined lowest tier level until all symbol positions on the plurality of reels are occupied with a value symbol, or until the particular number of free spins are exhausted.

5. The electronic gaming device of claim 1, wherein the instructions, which, when executed by the at least one processor, further cause the at least one processor to reselect the second set of game symbols randomly for each free spin of the particular number of free spins during the feature game.

6. The electronic gaming device of claim 1, wherein the instructions, which, when executed by the at least one processor, further cause the at least processor to generate the first set of game symbols, or the second set of game symbols according to a theme associated with a team selected by a player.

7. The electronic gaming device of claim 6, wherein the team selected by the player is a football team.

8. The electronic gaming device of claim 1, wherein each game tier of the plurality of game tiers is assigned a respective weight causing a first subset of game tiers of the plurality of game tiers to be selected less in comparison with a second subset of game tiers of the plurality of game tiers.

9. The electronic gaming device of claim 1, wherein the particular number of free spins is three free spins.

10. The electronic gaming device of claim 1, wherein the value symbols include at least one of a cash-on-reel symbol, a football symbol, a mini jackpot symbol, or a major jackpot symbol.

11. A computer-implemented method performed by an electronic gaming device comprising at least one memory and at least one processor coupled with the at least one memory, the method comprising:
determining a first game tier from a plurality of game tiers for playing a base game, each game tier of the plurality of game tiers being assigned a tier level and including a set of value symbols for display during game play, wherein each set of the value symbols included within each game tier have a value associated therewith within a predefined range of values, wherein a minimum value within the predefined range of values increases as the tier level increases;
determining for the base game a first set of game symbols from a plurality of game symbols to be randomly selected from for display on each reel of a plurality of reels, the first set of game symbols including at least value symbols from a set of value symbols corresponding to the first game tier and value symbols included in the game tiers at higher levels than the first game tier;
causing a randomly selected subset of the first set of game symbols to be displayed on the plurality of reels;
in response to one or more trigger symbols being displayed during the base game, triggering a feature game with a particular number of free spins;
evaluating the value symbols of the first subset of game symbols displayed on the plurality of reels;
determining the lowest tier level associated with the value symbols displayed on the plurality of reels;
assigning a new game tier to the feature game based on the determined lowest tier level displayed; and
determining for the feature game a second set of game symbols from the plurality of game symbols to be randomly selected from for the display on the plurality of reels, the second set of game symbols including value symbols corresponding to the new game tier and all other higher tier levels.

12. The computer-implemented method 11, further comprising displaying a subset of the second set of game symbols in a set of empty positions on the plurality of reels, wherein each empty position of the set of empty positions does not include a displayed game symbol.

13. The computer-implemented method 12, further comprising causing display of a value symbol within one of empty positions on the plurality of reels, wherein the value symbol is selected from the second set of game symbols including value symbols corresponding to the new game tier and all other higher tier levels.

14. The computer-implemented method 12, further comprising reassigning the new game tier having a new tier level randomly selected to be equal to or higher than the determined lowest tier level until all symbol positions on the plurality of reels are occupied with a value symbol, or until the particular number of free spins are exhausted.

15. The computer-implemented method 11, further comprising reselecting the second set of game symbols randomly for each free spin of the particular number of free spins during the feature game.

16. The computer-implemented method of claim 11, further comprising generating the first set of game symbols, or the second set of game symbols according to a theme associated with a team selected by a player.

17. The computer-implemented method of claim 16, wherein the team selected by the player is a football team.

18. The computer-implemented method of claim 17, wherein each game tier of the plurality of game tiers is assigned a respective weight causing a first subset of game tiers of the plurality of game tiers to be selected less in comparison with a second subset of game tiers of the plurality of game tiers.

19. The computer-implemented method of claim 11, wherein the particular number of free spins is three free spins.

20. An electronic gaming application server communicatively coupled with an electronic gaming device, the electronic gaming application server comprising:
at least one memory with instructions stored thereon; and
at least one processor in communication with the at least one memory, wherein the instructions, when executed by the at least one processor, cause the at least one processor to:
determine a first game tier from a plurality of game tiers for a base game being played on the electronic gaming device, each game tier of the plurality of game tiers being assigned a tier level and including a set of value symbols for display during game play, wherein each set of the value symbols included within each game tier have a value associated therewith within a predefined range of values, wherein a minimum value within the predefined range of values increases as the tier level increases;
determine for the base game a first set of game symbols from a plurality of game symbols to be randomly selected from for display on each reel of a plurality of reels of the electronic gaming device, the first set of game symbols including at least value symbols from a set of value symbols corresponding to the first game tier and value symbols included in the game tiers at higher levels than the first game tier;
cause a randomly selected subset of the first set of game symbols to be displayed on the plurality of reels of the electronic gaming device;
in response to one or more trigger symbols being displayed on the plurality of reels during the base game, trigger a feature game with a particular number of free spins;
evaluate the value symbols of the first subset of game symbols displayed on the plurality of reels;
determine the lowest tier level associated with the value symbols displayed on the plurality of reels;
assign a new game tier to the feature game, a new tier level of new game tier is randomly selected to be at least equal to or higher than the determined lowest tier level; and
determine for the feature game a randomly selected second set of game symbols from the plurality of game symbols, the second set of game symbols including value symbols corresponding to the new game tier and all other higher tier levels.
